(19) United States
(12) Patent Application Publication
(10) Pub. No.: US 2013/0020875 A1
(43) Pub. Date: Jan. 24, 2013

(54) BATTERY PACK FOR AN ELECTRONIC DEVICE

(71) Applicants: John A. Wozniak, Houston, TX (US); Craig A. Walrath, Houston, TX (US)

(72) Inventors: John A. Wozniak, Houston, TX (US); Craig A. Walrath, Houston, TX (US)

(21) Appl. No.: 13/637,599

(22) PCT Filed: Jun. 30, 2010
(86) PCT No.: PCT/US10/40621

§ 371 Date: Sep. 26, 2012

(51) Int. Cl. H02J 3/00; H02J 1/00

(52) U.S. Cl. 307/72; 307/43; 307/80

(57) ABSTRACT

A battery pack for providing power to an electronic device which includes a rechargeable battery, a non-power line power source, and a circuit configured to selectively deliver direct current (DC) power from the non-power line source to at least one of the rechargeable battery and to the device based on communication between the electronic device and the battery pack. The electronic device can deliver system power to the device from at least one of the alternating current (AC) power source, a battery and one or more non-power line sources based on power detected from one or more of the power sources.

### BACKGROUND

A portable electronic device may include a power source such as a rechargeable battery to power the device. The portable electronic device may be mobile allowing it to be easily transported to different locations. However, the device may be transported to a location where access to an alternating current (AC) power source to charge the battery may no be convenient.

### BRIEF DESCRIPTION OF THE DRAWINGS

For a better understanding of example embodiments of the invention as well as further features thereof, reference is made to the following description which is to be read in conjunction with the accompanying drawings where:

FIG. 1 is a block diagram of a battery pack and an electronic device in accordance with an example embodiment of the present invention; and

FIG. 2 is a flow chart showing the operation of the battery pack of FIG. 1 in accordance with an example embodiment of the invention;

FIG. 3 is a flow chart showing the operation of the electronic device of FIG. 1 in accordance with an example embodiment of the invention;

FIG. 4 is a flow chart showing the operation of the electronic device of FIG. 1 in accordance with an example embodiment of the invention;

FIG. 5 is a flow chart showing the operation of the battery pack and electronic device of FIG. 1 in accordance with an example embodiment of the invention; and

FIG. 6 is a block diagram of an electronic device in accordance with another example embodiment of the invention.

### DETAILED DESCRIPTION

Reference will now be made in detail to embodiments of the present invention shown in the accompanying drawings. Furthermore, in the following detailed description, numerous specific details are set forth in order to provide a thorough understanding of example embodiments of the present invention. However, embodiments of the present invention can be practiced without these specific details.

The following detailed description, in accordance with example embodiments of the present invention, provides an electronic device that is configured to select power sources from the device as well as the battery pack to power the device. The device can be configured to make power related and other decisions based on user specified preferences, algorithms, sets of priorities and the like. In one embodiment, the battery pack includes a rechargeable battery, a non-power line power source, and a circuit configured to selectively deliver direct current (DC) power from the non-power line source to at least one of the rechargeable battery and the electronic device based on communication between the device and the battery pack. In another embodiment, the electronic device includes a first power source such as a first battery, and a controller configured to communicate with an external battery pack to select receiving power from a second power source including at least one of the second battery and a non-power line power source based on available power at the power sources. In another embodiment, the electronic device comprises a first power source including a first battery, a second power source including an input for receiving power from an external alternating current (AC) adapter, and a controller configured to control delivery of system power to the electronic device from one or more of the first power source, the second power source, and a third power source from one or more non-power line sources based on power detected from one or more of the power sources.

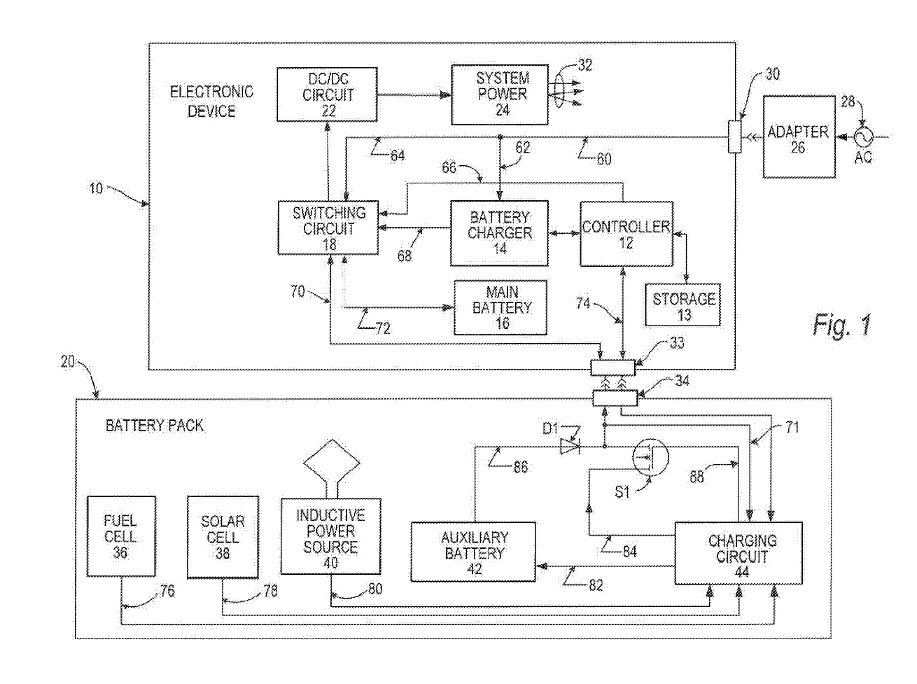

FIG. 1 is a block diagram showing one embodiment of the present invention. Shown is an electronic device 10 configured to select to receive power from a battery pack 20 to power the device as well as to control the battery pack to charge its own battery based on the power available from the device and the battery pack. As explained below in further detail, the device can be configured to make power related and other decisions based on user specified preferences, algorithms, sets of priorities and the like. The electronic device 10 includes a controller 12, a storage device 13, a battery charger 14, a main battery 16, a switching circuit 18, a DC/DC circuit 22, and a system power module 24. The electronic device 10 comprises a connector 30 for receiving DC power from an alternating current (AC) adapter 26 which converts input AC power from AC power source 28 into DC power. The battery pack 20 includes a connector 34 and a device 10 includes a connector 33 which are configured to allow the battery pack to be detachably coupled to the device and allow the battery pack to be external to the device. The battery pack 20 includes an auxiliary battery 42, non-power line power sources (36, 38, 40) capable of providing DC power, and a charging circuit 44.

The battery pack 20 and the electronic device 10 can be configured to be coupled to each other and communicate information and transmit power between each other in a unidirectional or bidirectional manner. For example, the device 10 can communicate with the battery pack 20 by sending a signal to the battery pack requesting power from the battery pack. In one embodiment, the charging circuit 44 can be configured to selectively deliver DC power from the non-power line sources to the auxiliary battery 42 and/or to the electronic device 10 based on an input signal from the device to the circuit. In another embodiment, device 10 can have access to power sources, such as AC power source 28 and main battery 16, and can transmit power from these sources to battery pack 20 to charge the auxiliary battery 42. In another example, battery pack 20 can communicate with the device 10 by sending a signal from the battery pack to the device indicating information about the battery pack such as information regarding amount of power available at the battery pack, type of power sources available at the battery pack and any other power related information which may be of use to device. The device 10 can use this information to make power related decisions such as deciding which non-power lines sources to select to receive to power the device and/or charge the main battery 16. In other words, in one embodiment, the device 10 and battery pack 20 can transmit power to each other to charge the battery of the other. The controller 12 is shown being associated with the electronic device 10. In another embodiment, the battery pack 20 can include a controller configured to support communication with the controller 12 including facilitating transmission of information and/or power between the battery pack and the device.

The electronic device 10 can be any device having data processing capability such as a portable computer, a notebook computer, laptop computer, tablet computer, desktop computer, mobile phone, global positioning system (GPS) device. MP3 player or any other device. For example, the electronic device 10 can be a notebook computer with a base member with a keyboard rotatably coupled to display member with a display wherein a bottom surface of the base member includes a connector for electrically connecting to the battery pack. The battery pack 20 as well as the device 10 can be supported in housings having any form and shape. For purposes of clarity, the electronic device shown in FIG. 1 omits other components such as communications devices, input/output I/O devices and other devices for operation of the electronic device.

The electronic device 10 is shown as having access to several potential sources or electrical power. For example, the electronic device 10 can receive DC power from the AC power source (via AC adapter 26), the main battery 16 and the battery pack 20. The battery pack 20 can provide several sources of DC power including power from the auxiliary battery 42 and non-power line power sources including the fuel cell 36, the solar cell 38, and the inductive power source 40. The power sources can be connected to the pitching circuit 18 which can be configured to select one or more of the power sources and deliver the selected power to power the device 10, charge the main battery 16, charge the auxiliary battery 42 or a combination thereof. In one embodiment, the switching circuit 18 can be configured to receive power from the main battery 16 (via line 72), the battery pack 20 (via line 70) and the AC adapter 26 (via line 60). The controller 12 can communicate with the switching circuit 18 over line 66. In another embodiment the controller 12 can also communicate with the switching circuit 18 to transmit power over line 70 to the battery pack 20 to charge the auxiliary battery 42.

The battery pack 20 and device 10 can be electrically connected to each other via connector 33 of the device and connector 34 of the battery pack. The battery pack 20 can provide power to the electronic device 10 via line 70. The battery pack 20 can also receive power from the device 10 to charge the auxiliary battery 42. In one embodiment, the connector 33 can be a multiple-pin connector located on the bottom surface of a housing of the notebook computer for mating to the corresponding multiple-pin connector 34 located on a top surface of a housing of the battery pack 20. The controller 12 can communicate with the battery pack 20 over line 74 when the device and battery pack are connected to each other, for example, through respective connectors 33, 34. The lines 70, 74 can be grouped together as part of the connectors 33, 34. Although the battery pack 20 and the device 10 are shown having connectors for establishing a connection to each other, it should be understood that other connection techniques may be employed, such as, cabling, wireless connection or any other means for attachment known in the art. For example, the connection mechanists for communicating power and information can be implemented using inter-integrated circuit interface and protocol or other similar mechanism.

The AC adapter 26 can be configured to convert AC line voltage (typically 110V or 220V) from the AC power source 28 to a particular DC voltage for powering the electronic device 10. For example, the electronic device 10 can be a notebook computer in which case it could require DC voltage in the range of +18V to +19V. The AC adapter 26 can include components such as a voltage regulator, transformer, rectifier, and line filter for providing a regulated output DC power (voltage and current). The AC adapter 26 can be configured to provide power for recharging the main battery 16 for a period of time thereby allowing the size of the adapter to be relatively small. The DC/DC circuit 22 can include a voltage regulator configured to receive input DC power from the switching circuit 18 and provide an output regulated DC voltage to the system power module 24. The DC/DC circuit 22 can be configured to step down the DC input voltage to a particular DC output voltage to meet the power requirements of the device 10. In a notebook computer embodiment, the DC/DC circuit 22 could be configured to step down the input voltage to provide multiple output voltages such as 5V, 3V and 1.5V and the like. The system power module 24 can include various output voltage rails 32 to provide system power distribution required by electronic components of the electronic device 10.

The battery charger 14 can be configured to provide regulated output current to recharge the main battery 16 through the switching circuit 18 in response to the power needs of the main battery. In one example, the main battery 16 can be a lithium-ion battery comprising battery cells. The battery charger 14 can be current limited to prevent overcharging (and overheating) of the battery ceils. The battery charger 14 can deliver power (i.e., voltage and current) based on feedback signals from the main battery 16. The main battery 16 can include sensors for sensing battery information, such as level of charge, which can be communicated to the controller 12. The controller 12 can be configured to use this information to determine whether to direct power into (or out of) the main battery 16 based upon various factors such as the load requirements of the device 10 and the level of stored charge in the main battery and the like. For example, the battery pack 20 can send the device 10 information about the battery pack such as the amount of power available at the battery pack, type of power sources available at the battery pack and any other power related information which may be of use to the device. The device 10 can use this information to make power related decisions such as deciding winch non-power lines sources to select to receive to power the device, charge the main battery 16 as well as transmit power to the battery pack 20 to charge the auxiliary battery 42.

The battery pack 20 is shown in FIG. 1 as having three non-power line power sources and power available from the auxiliary battery 42. Non-power line power sources can include power sources that provide power without a connection to a power line such as AC power from a power receptacle. The auxiliary battery 42 can be a lithium-ion battery with associated battery cells. The non-power line power sources are shown include the fuel cell 36, the solar cell 38 and the inductive power source 40. The fuel cell 36 is configured to convert stored fuel to DC power which is carried over line 76 to the charging circuit 44. For example, the fuel cell 36 can include a user accessible reservoir to house fuel which the fuel cell would convert to electrical energy. The solar cell 38 is configured to convert light energy to DC power which is carried over line 78 to the charging circuit 44. For example, the solar cell 38 can include a solar panel with at least a portion of the panel disposed on the exterior surface of the battery pack so that it can receive light energy for conversion to electrical energy. The solar cell 38 can be integrated or built into the battery pack 20 or configured to be detachably coupled to the battery pack and/or electronic device.

The inductive power source 40 can be configured to convert electromagnetic (EM) energy to DC power which is carried over line 80 to the charging circuit 44. For example, the inductive power source 40 can include an embedded antenna (not shown) disposed on a surface of a housing for supporting the battery pack. The embedded antenna can include circuitry configured to detect the presence of an external EM field and convert the energy from the EM field to electrical energy. The EM field can be provided from an external device (not shown) that energizes a transmitting antenna in a charging pad that is located in close proximity to the embedded antenna associated with the inductive power source 40. The inductive power source 40 can include a matching tank circuit to provide a regulated output voltage by rectifying AC voltage and filtering it to a predetermined DC voltage. The use of inductive power to charge a battery is sometimes referred to as wireless charging or contact-less charging. It can provide a safe method of providing power because there are no direct electrical connections needed to transfer power. The inductive power source 40 is described in the context of EM fields, however, it should be understood that other wireless charging techniques can be used such as radio frequency (RF), microwave, magnetic resonance and the like. The inductive power source 40 can he integrated or built into the battery pack 20 or confirmed to be detachably coupled to the battery pack.

Although three non-power line power sources are shown, it should be understood that a greater or lesser number of non-power line power sources can be used. Further, it should be understood that other power sources of different technologies can be used. For example, the battery pack 20 could, include a power source that converts kinetic energy to electrical energy, a power source that converts thermal energy to electrical energy, a power source that converts wind energy to electrical energy and the like. The non-power line sources can be integrated or built into the battery pack or configured to be detachably coupled to the battery pack and/or electronic device.

The charging circuit 44 can be configured to isolate power received from the non-power line source and direct the power to the auxiliary battery 42 or to the electronic device 10 based on communication between the device and the battery pack. For example, the electronic device 10 can send a signal or request to the charging circuit 44 to direct power to the auxiliary battery 42 to recharge the battery. The charging circuit 44 can respond to the signal by directing a constant source of current from the non-power line sources to charge the auxiliary battery 42. In another example, the electronic device 10 can send a signal (over line 74) to the charging circuit 44 to direct power directly from the battery pack 20 to the device 10 which can use the power to charge the main battery 16 or provide system power for the device. For example, when the auxiliary battery 42 is fully charged, the controller 12 can send a signal to the battery pack 20 requesting to receive additional power from the battery pack. The charging circuit 44 can respond to the request by turning switch S1 off (via line 88) which causes current to stop flowing to the auxiliary battery 42 over line 82, and instead, allow current to begin flowing through line 84 of the battery pack and line 70 of the device 10. Steering diode D1 helps prevent current from flowing back into the auxiliary battery 42 output on line 86 when the voltage on line 70 exceeds the voltage on line 86. The charging circuit 44 can include an output switch which can respond to signals from the device 10. The charging circuit can be configured to respond to such signals and determine whether to provide power on line 82 to charge the auxiliary battery 42, or on line 84 to provide power to the device 10 or to recharge the main battery 16. In other example, the electronic device 10 can send a signal to the charging circuit 44 to direct the battery pad 20 to charge auxiliary battery 42 and to provide power to the device 10 from the non-power line sources. In another embodiment, the charging circuit 44 can be configured to receive power from the device 10 to charge the auxiliary battery 42.

The controller 12 can comprise a state machine implemented as discrete hardware logic components configured to operate without having to execute instructions. Although one controller 12 is shown in FIG. 1, it should be understood that there can be more than one controller distributed between the battery pack and the device. In one example, the functionality of the controller 12 can comprise logic components distributed between the battery pack and the device 10. In another example, the battery pack 20 can include a controller configured to communicate with the controller 12. The controller 12 can be implemented in hardware, software, firmware or a combination thereof. The controller 12 can be a general purpose microprocessor, microcontroller, digital signal processor, etc. configured to execute software programs. The controller 12 can comprise any general purpose processor capable of executing instructions in storage for controlling the operation of the device. The controller 12 can execute instructions from the storage device 13. The storage device 13 can be configured for storing instructions to control operation of the device when executed by the controller 12. The storage device 13 can include various storage media, for example, magnetic storage (e.g., hard disks, floppy disks, tape, etc.), optical storage (e.g., compact disk, digital video disk, etc.), or semiconductor memory (e.g., static or dynamic random-access-memory (SRAM or DRAM), read-only-memory (ROM), FLASH memory, magnetic random access memory (MRAM) and the like.

In one embodiment, the controller 12 can be an embedded controller capable of providing a power management command interface between the various potential sources of power including the AC power source 28, the main battery 16 and the power sources at the battery pack 20. The controller 12 can process communication signals between other components of the device 10 including storage devices such as memory, disk drives and input/output (I/O) devices such as a display, a keyboard interface, a touch interface and other components of the device.

The controller 12 can be configured to communicate with the electronic device 10 by providing power control signals to the device based on power conditions of the device. The controller 12 can also communicate with the battery pack 20 by sending control signals to the battery pack over path 74 based on the power conditions of the device such as, for example, the availability of power at the power sources. The controller may check for availability of power by measuring the power (voltage and/or current) from a power source using sensors or other mechanisms capable of providing status information such as an indication of power. The availability of power may be include the power capacity of the power source and can range from full availability (full capacity) to no availability (discharged or no capacity). As explained above, in one embodiment, the battery pack 20 can include a controller, alone or in combination with the charging circuit 44, configured to communicate with the controller 12. Such a battery pack controller can send a signal to the device 10 indicating information about the battery pack such as information regarding amount of power available at the battery pack, type of power sources available at the battery pack and any other power related information. The controller 12 can use this information to make power related decisions such as deciding which non-power lines sources to select for receiving to power the device and/or charge the main battery 16 of the device.

In one embodiment, the device 10 can provide a user interface to allow a user to input information such a user specified power preferences which can be used by the controller to make power selection decisions. The user interface can allow the user to change and override power selection decisions of the controller 12. The user interface can be implemented in hardware, software or a combination thereof. The user preferences or any input from the user can be stored in memory for later retrieval and use by the controller 12 such as for making power related decisions. For example, the user interface can be implemented as an application program that generates a display screen to allow a user to input power preferences. For instance, suppose the device 10 is powered off for a relatively long period of time and the battery is not fully charged. When the device is powered on, the user can use the interface to enter a preference specifying that the controller select power from the AC power source 28 or power from the solar cell 38 of the battery pack 20 to recharge the main battery 16 instead of having the controller select the fuel cell 36 to charge the main battery.

The controller 12 can be configured to control power related functions of the electronic device 10 based on conditions of the device. For example, the controller 12 can monitor the power needs of the device 10, the availability of power from the AC power source 28, the level of charge of the main battery 16, the level of charge of the auxiliary battery 42, and the availability of power from the battery pack 20 and the like. The controller 12 can be programmed to make power related decisions based on the availability of power from these power sources. The auxiliary battery 42 of the battery pack 20 can be charged based on the availability of power from the non-power line power sources such as the fuel cell 36, the solar cell 38 and the inductive power source 40. The charging of the auxiliary battery 42 can occur independently of the charging of the main battery 16 of the device 10. The charging circuit 44 can control switch S1 to direct power to charge the auxiliary battery 42 when the battery pack 20 is not attached to the device 10, or when the battery pack is attached to the device 10 and the power needs of the device are less than the power available from the non-power line sources. The charging circuit 44 can be configured to operate alone or in combination with additional logic such as a controller to facilitate communication with the device 10. For example, the charging circuit 44 can be configured to receive power over line 71 front the device 10 to charge the auxiliary battery 42. The charging circuit 44 may include logic and/or a separate controller to selectively control receipt of power from the device 10 over line 71 and transmission of power to the device over line 70. The charging circuit 44 can be configured to exchange power related information with the device 10 over line 74. For example, the charging circuit 44 can be configured to determine and report to the device 10 the amount of power available at the battery pack based on the power available from the auxiliary battery 42 and the non-power line sources. The charging circuit 44 can also be configured to determine and report to the device 10 the type of power sources available at the battery pack and any other power related information which may be of use to the device. The various power sources may be in thirteen states of availability to provide power (ranging from full capacity to no capacity). For example, power from the AC power source 28 and power from the solar cell 38 may not be available or only partially available. The device 10 is capable of handling these conditions and making decisions for charging the batteries (the main battery 16 and the auxiliary battery 42) and for providing system power for the device 10 as explained below in further detail.

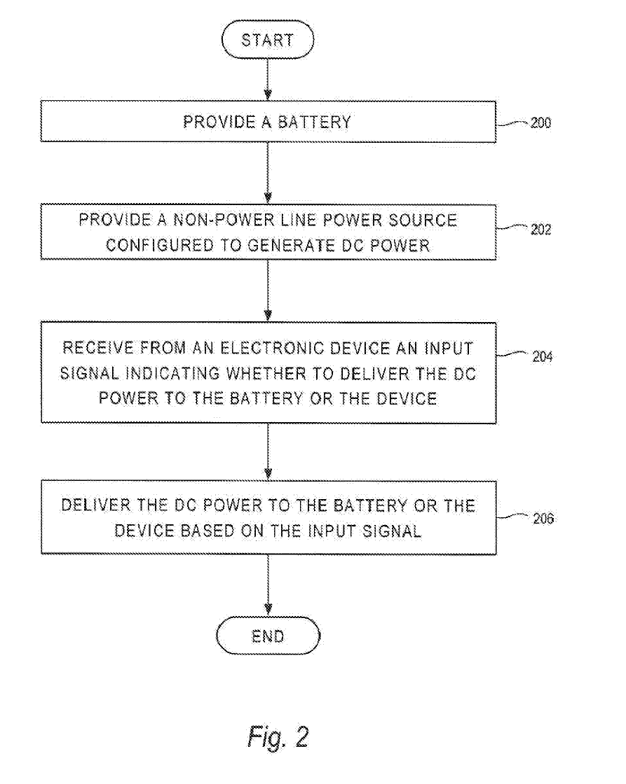

FIG. 2 is a flow chart showing the operation of the battery pack 20 for the electronic device 10 of FIG. 1 in accordance with an embodiment of the invention. A description is provided of the operation of the battery pack 20 providing power to the electronic device 10. The operation is described from the perspective of the battery pack. It should be understood, that though the operation is depicted sequentially as a matter of convenience, at least some of the actions shown can be performed in a different order and/or performed in parallel. Additionally, some embodiments may perform only some of the actions shown.

At block 200, the battery pack 20 is configured with a power source such as a battery. For example, the battery pack 20 can be configured with the auxiliary battery 42 as the power source. At block 202, the battery pack 20 is configured to include a non-power line power source to provide DC power. For example, the battery pack 20 can be configured with the solar cell 38 as the non-power line power source. However, it should be understood the battery pack can be configured with different non-power line power sources as well as a greater or lesser number of power sources. At block 204, the battery pack 20 waits to receive from the electronic device 10 an input signal indicating whether to deliver the DC power to the auxiliary battery 42 or the device. For example, assuming that the battery pack 20 is connected to the electronic device 10, the controller 12 can send a signal over line 74 to the charging circuit 44. In other embodiments, the charging circuit 44 can be configured to monitor or periodically check for the input signals from the device. In other embodiments, the battery pack 20 can communicate with the device 10 by sending information about the battery pack such as information regarding amount of power available at the battery pack, type of power sources available at the battery pack and any other power related information. The device 10 can use this information to make power related decisions such as deciding which non-power lines sources to select for receiving to power the device, charge the main battery 16, charge the auxiliary battery 42 or a combination thereof. The battery pack 20 can also receive power from the device 10 to charge the auxiliary battery 42.

At block 206, the battery pack 20 delivers the DC power to the auxiliary battery 42 or the device 10 based on the input signal from the device. For example, the electronic device 10 may have been configured to have the battery pack 20 deliver power from the solar cell 38 to the auxiliary battery 42. As such, the charging circuit 44 receives from the controller 12 a signal instructing the circuit to direct power from the solar cell 38 to the auxiliary battery 42. In this manner, the power delivered to the auxiliary battery 42 may be used to recharge the auxiliary battery. On the other hand, the electronic device 10 may have been configured to have the battery pack 20 deliver power from the solar cell 38 directly to the device 10 instead of to the auxiliary battery 42. Accordingly, the charging circuit 44 receives from the controller 12 a signal instructing the circuit to direct power from the solar cell 38 to the device 10 instead of to the auxiliary battery 42. In this manner, the electronic device 10 can use this power to provide system power to the device and/or to charge or recharge the main battery 16 of the device. In another example, the battery pack 20 may be configured to simultaneously deliver power from the solar ceil 38 to the auxiliary battery 42 and power to the electronic device 10. In this case, the charging circuit 44 receives from the controller 12 a signal instructing the circuit to direct a portion of power from the solar cell 38 to the auxiliary battery 42 and another portion to the device 10. It should be understood that these were example power selection configurations and other configurations are possible including combinations thereof.

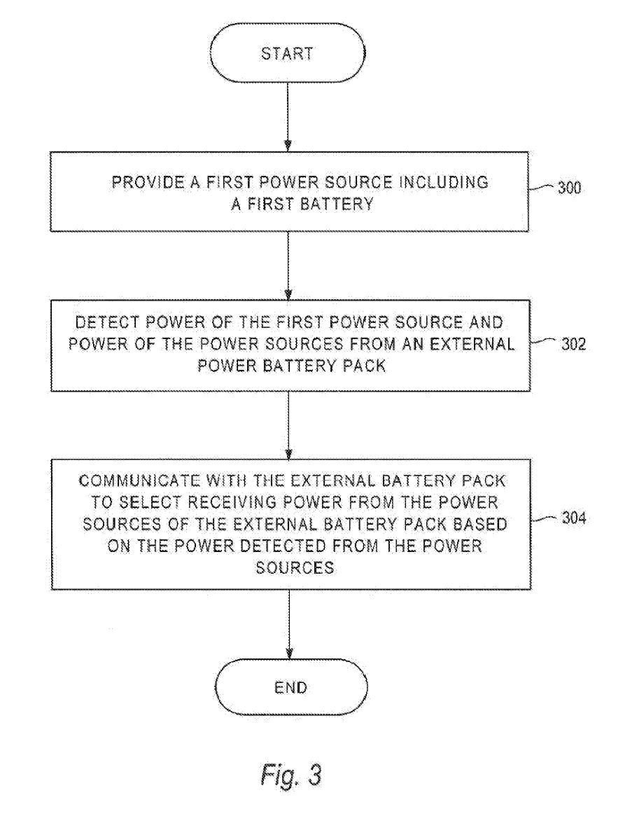

FIG. 3 is a flow chart showing the operation of the battery pack 20 for the electronic device 10 of FIG. 1 in accordance with another embodiment of the invention. A description is provided of the operation of the electronic device 10 receiving power from the battery pack 20. The operation is described from the perspective of the device 10. It should be understood, that though the operation is depicted sequentially as a matter of convenience, at least some of the actions shown can be performed in a different order and/or performed in parallel. Additionally, some embodiments may perform only some of the actions shown.

At block 300, the electronic device 10 is configured with a first power source such as a first battery. For example, the device 10 can be configured to have the main battery 16 as the first battery and configured to provide system power to the device 10 and have the power from the battery pack to recharge the battery. At block 302, the electronic device 10 checks or detects the available power of the first power source and power of the power sources from the external power battery pack 20. For example, the controller 12 can be configured to check the available power from the main battery 16 and power from the power sources of the battery pack 20. In another embodiment, the controller 12 can be configured to monitor for changes in the available power and make decisions based upon the changes. In other embodiments, the device 10 can communicate with the battery pack 20 by receiving information about the battery pack such as information regarding amount of power available at the battery pack, type of power sources available at the battery pack and any other power related information. The device 10 can use this information to make power related decisions such as deciding which non-power lines sources to select for receiving from the battery pack to power the device, charge the main battery 16 of the device, transmit power to the battery pack 20 to charge the auxiliary battery 42 or a combination thereof.

At block 304, the electronic device 10 communicates with the battery pack 20 to select receiving power from the power sources of the external battery pack 20 based on the power detected at the power sources. For example, the controller 12 can send a signal to the battery pack 20 to select to receive power from the auxiliary battery 42 or from a non-power line power source, such as the solar cell 38, of the battery pack. In one case, the battery pack 20 can respond to the request accordingly and direct power to the device 10. The device 10 can use the received power to provide system power to the device (via the system power module 24) or to recharge the main battery 16. As explained below in further detail, the device can be programmed to make power selection and other decisions based on user specified preferences, algorithms, sets of priorities and the like.

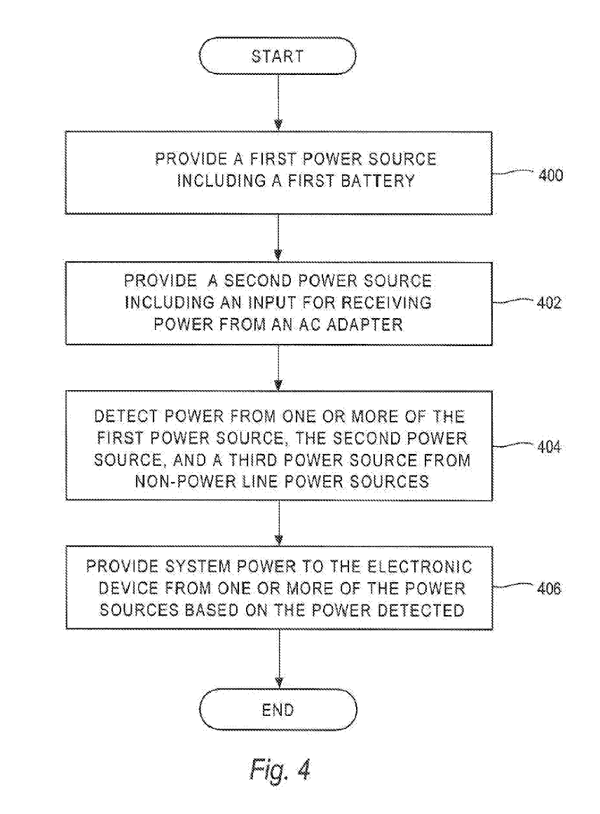

FIG. 4 is a flow chart of the operation of the electronic device 10 of FIG. 1 in accordance with another embodiment of the invention. In particular, a description is provided of the operation of the electronic device 10 providing power to the device from power sources including those of the battery pack 20. The operation is described from the perspective of the device 10. It should be understood, that though the operation is depicted sequentially as a matter of convenience, at least some of the actions shown can be performed in a different order and/or performed in parallel. Additionally, some embodiments may perform only some of the actions shown.

At block 400, the electronic device 10 is configured with a first power source including a first battery. For example, the device 10 can be configured with the main battery 16 as the first power source. At block 402, the electronic device 10 is configured to provide a second power source including an input for receiving power from an AC adapter. For example, the device 10 can be configured to receive power from AC power source 28. At block 404, the electronic device 10 detects power from one or more of the first power source, the second power source, and a third power source from non-power line sources. For example, the controller 12 can detect power from the main battery 16 (first power source), the AC adapter (the second power source) and the external battery pack 20 (third power source). The detection of power can include measuring the power (current and voltage) available at the power sources. The controller 12 can also monitor the power available at these power sources and the power demands of the device 10. At block 406, the electronic device 10 provides system power to the device from one or more of the power sources based on the power detected at the power sources. For example, the controller 12 can direct power to the system power module 24 to provide system power to the device 10 based on the power available at the power sources. As explained below in further detail, the device can be programmed to make these decisions based on user specified preferences, algorithms, sets of priorities and the like. In other embodiments, the battery pack 20 can communicate with the device 10 by receiving information about the battery pack such as information regarding amount of power available at the battery pack, type of power sources available at the battery pack and any other power related information. The device 10 can use this information to make power related decisions such as which non-power lines sources to select for receiving from the battery pack to power the device, charge the main battery 16 of the device, transmit power to the battery pack 20 to charge the auxiliary battery 42 or a combination thereof.

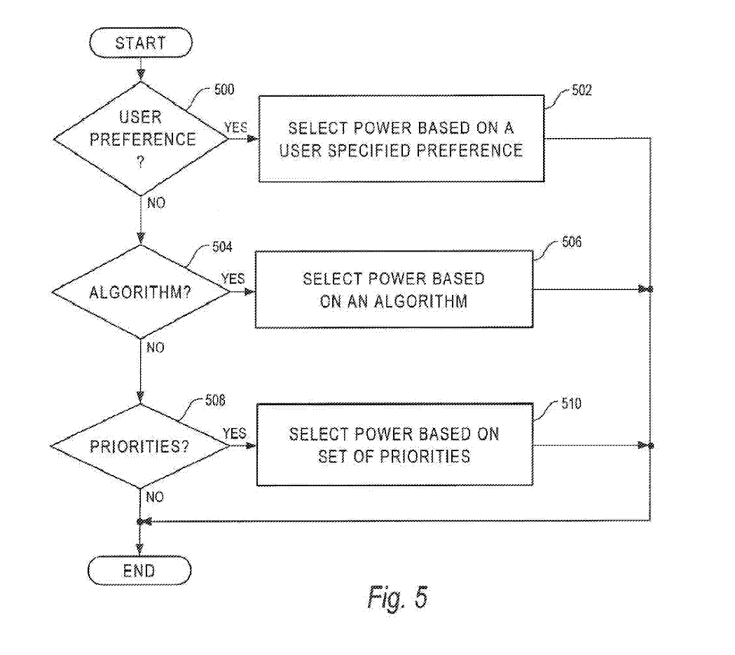

FIG. 5 is a flow chart of the operation of the electronic device 10 of FIG. 1 in accordance with another embodiment of the invention. In particular, a description is provided of the operation of the electronic device 10 using various techniques for selecting power sources to provide power to the device. It is assumed that the electronic device 10 has access to multiple power sources from which to select. It is further assumed that the device 10 can check the available power sources and power requirements of the device and make power related decisions. In other embodiments, the device 10 can communicate with the battery pack 20 by receiving information about the battery pack such as information regarding amount of power available at the battery pack, type of power sources available at the battery pack and any other power related information. The device 10 can use this information alone or in combination with user specified preferences, algorithms and set of priorities, as explained further below, to make power related decisions such as deciding which non-power lines sources to select for receiving from the battery pack to power the device, charge the main battery 16 of the device, transmit power to the battery pack 20 to charge the auxiliary battery 42 or a combination thereof.

It should be understood, that though the operation is depicted sequentially as a matter of convenience, at least some of the actions shown can be performed in a different order and/or performed in parallel. Additionally, some embodiments may perform only some of the actions shown.

At block 500, the electronic device 10 checks if a user has specified a particular preference of power sources from which the device is to select. If so, then the device 10 proceeds processing to block 502 in which the device selects power sources based on user specified power preferences. For example, multiple power sources may be available at different times, and the user may specify which power sources the device is to select from in different cases. For instance, power may be available from the AC source and the non-power line power sources, such as power from the solar cell 38 and the inductive power source 40. There may be different scenarios where the user might specify which preferred power sources are to be used by the device. With all three sources available, the user may specify that the device 10 select power from the solar cell 38 because it may cost less than either of the other two sources or for environmental reasons. In another example, the user may specify that the device select power from the inductive power source 40 even if power from the solar cell 38 is available. In this case, the user may have specified the inductive power source 40 because it was more convenient to use, requiring no wires to connect to the system and/or specified the use of power from the solar cell 38 because it was not able to provide sufficient charge. In another example, the user may specify that the device select power from the AC power source 28 because it is less costly than power from the inductive power source 40 or perhaps more convenient to use than solar at the time. As explained above, the device 10 can provide a user interface through which the user can enter these preferences. The device 10 can provide a user, such as an end user, system supplier, system administrator or other person the ability to provide power preferences and also the ability to change those as desired. This could be achieved using hardware, software or a combination thereof.

On the other hand, if the device detects that the user has not specified a user power preference, then the device 10 proceeds processing to block 504 in which the device checks if the selection of power sources is to be based on an algorithm. If so, then the device 10 proceeds to block 506 in which the device makes power selections based on a particular algorithm. For example, an algorithm can include instructions to have the device select power from power sources based on the relative cost of the power sources such as selecting the lowest cost power source first. The algorithms can be generated in a predetermined manner or in a dynamic manner during the operation of the device.

If the device determines that it is not to make a power source selection based on an algorithm, then the device 10 proceeds processing to block 508 in which the device checks if the selection of power sources is to be based on a set of priorities. If so, then the device 10 proceeds to block 510 in which the device selects the power sources based on a set of priorities. The device can provide the capability to provide a default set priorities. The device can also provide a user the ability to change the act of priorities at a later time. This capability can be provided through a user interface as explained above. In one example, a first set of priorities can specify that power is to be provided based on the lowest cost power available. The device 10 can be configured to use the set of priorities to provide as much of the available power to power the device 10, charge the auxiliary battery 42, charge the main battery 16 and so on. For example, if sufficient power is not available solely from the lowest cost power solution, the device 10 could be configured to have a default set of priorities specifying that the available power is to be provided to the auxiliary battery 42, the main battery 16, system power via the system module 24 and so on. If the device 10 is powered off, the set of priorities could specify that the device charge the auxiliary battery 42 first and then the main battery 16. On the other hand, if the device 10 is powered on, the set of priorities could specify that the device provide power to the device through the system power module 32 first, then charge the auxiliary battery 42 and then the main battery 16. It should be understood that these are example set of priorities and the device can be configured with a different set of priorities. The device can be configured with default set of priorities which can be changed as desired by the user. As explained above, the priorities can be specified by the user through a user interface provided by the device 10. It should be also understood that alternate power sources as well as power sources of different technologies can be used.

In another example, assume that the electronic device has access to multiple power sources. Further assume that a second set of priorities specifies that the device 10 utilize the next lowest cost power source available to supplement the lowest cost power solution if the lowest cost source is not able to provide sufficient power as in the above first set of priorities. For instance, suppose the device 10 has access to three power sources including the solar cell 38, the AC power source 28 and the inductive power source 40. If all three of these power sources are available, the set of priorities could specify that the device 10 use as much of the power from the solar cell 38 (assuming it is the lowest cost solution) as possible. If power from the solar cell 38 is not sufficient, then the device 10 could also be configured to use power from the AC power source 28 (assuming it is less costly than power from the inductive power source 40) to provide supplemental power. If power from the AC power source 28 is not available then the set of priorities could specify that the device 10 select power from the inductive power source 40 for charging the batteries (main battery 16 and auxiliary battery 42 or combination thereof) and to supplement power from the solar cell 38. Another set of priorities could specify that the device 10 continue utilizing the next available power source if needed to supplement power if there is not sufficient power from the first two sources. It should be understood that these are example sets of priorities and the device can be configured with a different set of priorities, alternate power sources as well as power sources of different technologies.

The above provides a description of the operation of the device and the battery pack in accordance with example embodiments. For example, the device 10 is described as having the capability of making power selection decisions regarding powering the system and recharging the main battery 16 and the auxiliary battery 42. As explained below in further detail the device can be configured to make power related decisions under various scenarios. For illustrative purposes, it will be assumed that there are several potential sources of power as shown in FIG. 2. Furthermore, it will be assumed that the auxiliary battery 42 is rechargeable and that the more costly sources of power are used only when the other sources of power are either unavailable or insufficient to provide the required power (e.g., current) to maintain the electronic device powered on. It will be further assumed that some non-power line sources maybe more costly than other non-power line sources. For example, power from fuel cell 36 and inductive power source 40 may cost more than power from solar cell 38 and wind power to operate than the AC power source 28. It should be understood that the device 10 can be configured to make power related decisions based on various techniques including predetermined criteria, user specified preferences, algorithms and sets of priorities or a combination thereof.

In a first scenario, it will be assumed that the electronic device 10 has access to several sources of potential power and the device is either powered on or off. In this example, the controller 12 can be configured to direct available DC power (current) from the AC power source 28 (via line 64) to the switching circuit 18 to power the device through the DC/DC circuit 22. The current on line 64 can also be routed through the battery charger 14 (via line 68) to the switching circuit 18 to trickle charge the main battery 16. Therefore, the device 10 can select the AC power source 28 to provide the necessary energy to power the device and maintain the main battery 16 fully charged. The device 10 can therefore meet the power requirements of the device without requiring power from the battery pack 20.

In a second scenario, it will be assumed that the electronic device 10 is connected to the AC power source 28 (and available to provide power) and to the battery pack with power only available from the solar cell 38. In this scenario, the controller 12 can be configured to select power from the AC power source 28 to meet the power needs of the device 10 while it is powered on. In addition, the controller 12 can be configured to select to receive power from battery pack 20 to supplement the power from the AC power source 28. The controller 12 can also be configured to receive power from the solar cell 38 when it is converting light energy to electrical energy.

In a third scenario, it will be assumed that the electronic device 10 is connected to the AC power source 28 and available to provide power. Further, the main battery 16 is assumed to be partially or fully discharged with only one other power source being available to provide power from the battery pack 20. Under these conditions, the controller 12 can be configured to select power from the AC power source 28 to provide all the needed power for the system power rails 13 (through the system power module 24) and may have sufficient reserve to feed the battery charger 14 for recharging the main battery 16. In another example, the AC adapter 26 may be small in size (e.g., travel adapter) and may not have sufficient reserve capacity. In this case, the controller 12 can be configured to select to receive power from the battery pack 20 which can provide DC power (DC current over line 70) and through the switching circuit 18 to recharge the main battery 16. If the device is powered off, then the controller 12 can be configured to route power from the AC power source 28 to the battery charger 14 for recharging the main battery 16. Therefore, in this case, the controller would not have to use power from the battery pack 20.

In a fourth scenario, it is assumed that the electronic device 10 is connected to the AC power source 28. It is further assumed, that the main battery 16 is partially or fully discharged with only one other power source from the battery pack 20 being available. Under these conditions, with the device 10 being powered off, the controller 12 can select power from the AC power source 28 to provide all the needed power for the system power rails 13 through the system power module 24. However, the controller 12 can be configured to preferentially supplement the power from the AC power source with other power sources, if available. Further, the controller 12 can be configured to select other power sources to provide the necessary power required to recharge the main battery 16.

In a fifth scenario, it is assumed that the electronic device 10 is connected to the AC power source 28 and the device is powered off. It is further assumed that the other sources of power are available and that both batteries (main battery 16 and auxiliary battery 42) require some recharging. In this case, the controller 12 can select to receive power from the battery pack 20 to recharge the main battery 16 first and then recharge the auxiliary battery 42 afterward. The controller 12 can be configured to make these power selections based in part on the assumption that it was more important to recharge the main battery 16 before the auxiliary battery 42 would require servicing.

In a sixth scenario, it is assumed that the electronic device 10 is connected to the AC power source 28. Further, it is assumed that the device 10 is powered on and all the other sources of power are available to provide power. It may be considered important to provide sufficient power to power the device. Accordingly, the controller 12 can be configured to select to receive power from the battery pack 20 to provide all available current to power the device 10. In another example, suppose that the power sources of the battery pack 20 may not be able to provide sufficient to power the device and recharge both batteries (main battery 16 and auxiliary battery 42) at the same time. In this case, the controller 12 can be configured to provide the necessary power to first power the device and then recharge the main battery 16, if needed and to the extent excess current is available.

Embodiments of the present invention may provide advantages. For example, in the above scenarios, the controller 12 can be configured to select to receive power from the battery pack 20 to provide the system power to the device. In some embodiments, it may be preferable to configure the controller 12 to select power from the solar cell 38 rather than from the other power sources if available because the relative cost of solar energy power may be less than other potential power sources.

Another advantage of an example embodiment of the invention can include the capability of the device 10 to be configured to power the device from the battery pack 20 without having to be connected to the AC power source 28. By utilizing the auxiliary power capabilities of the battery pack 20, a user may have little need to physically connect the device 10 to the AC adapter 26 to power the device or recharge the main battery 16. For example, the inductive power source 40 provides power without having to be connected to AC power. Further, having the inductive power source 40 disposed in the battery pack may be less costly and less complex then having it is disposed in the device 10. An electronic device 10, such as a notebook computer, may have limited space for an inductive power source so it may be beneficial to have it disposed in the battery pack. Furthermore, having the inductive power source 40 in the battery pack 20 may allow a user the option to purchase this feature separately from the purchase of the computer if desired.

Another advantage of an example embodiment of the invention can include the ability of the battery pack 20 to increase the available battery time for a user. For example, the battery pack may be able to provide sufficient power throughout a relatively long period of time such as an eight-hour time period. An example embodiment of the battery pack 20 can be fully charged to provide power for at least such a period. In addition, the battery pack 20 can be recharged at a time when it is not in use, such as at night when the user is sleeping, by merely placing the device 10 and the battery pack 20 adjacent to a charging pad with an energizing field to activate the inductive power source 40. In this manner, the battery pack 20 can be wirelessly recharged at night and become fully charged by the morning. Alternatively, the battery pack 20 can placed adjacent to a recharging pad when not in use so that the battery pack can be fully charged and available when needed.

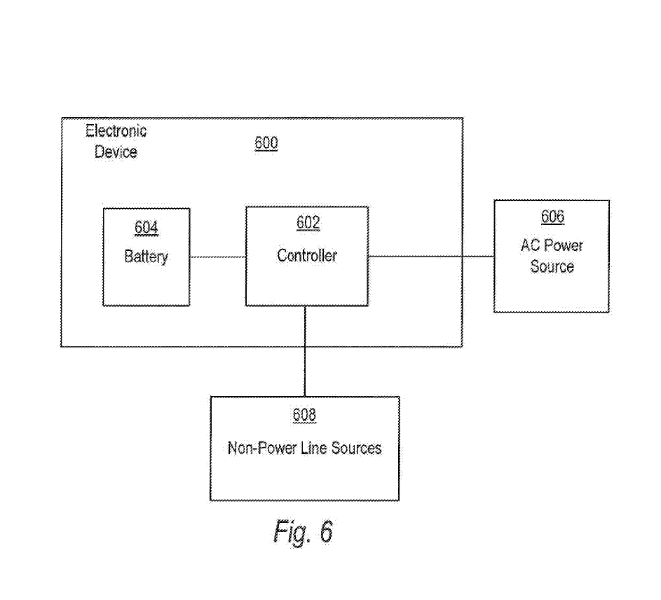

FIG. 6 is a block diagram showing an electronic device in accordance with another embodiment of the present invention. Shown is an electronic device 600 having a controller 602 configured to select various powers sources for providing system power to components of the device, charging of a battery of the device or a combination thereof. The device 600 includes a first power source 604 which can be a rechargeable battery. The device 600 includes an input for access to a second power source 606 which can comprise power from an external AC power source via an AC adapter. The device 600 is configured to have an input for access to a third power source 608 which can include non-power line sources such as those described above. The controller 602 can be configured to control delivery of power to the device 600 from one or more of the first power source 604, the second power source 606, and the third power source 608. The controller 602 can be configured to make this determination based on power detected from one or more of the power sources. Therefore, in one example, the electronic device 600 can deliver system power to the device from at least one of the battery 604, the AC power source 606 and one or more of the non-power line sources 608 based on power detected from one or more of these power sources.

The device 600 is similar to the device and can include components of device 10, hut they have been omitted for clarity. For example, the controller 602 can be configured to control delivery of system power to the electronic device 600 from one or more of the power sources simultaneously. The controller 602 can be configured to select a priority of power sources for delivering system power based on a set of priorities where the set of priorities can comprise at least one a predefined set of priorities, a user configurable set of priorities and a dynamically determined set of priorities. The controller 602 can be configured to control delivery of system power to the electronic device 600 based on at least one of available power at the power sources, relative cost of the power sources, user specified preferences and an algorithm. In one embodiment, non-power line sources 608 can functionality to communicate with the device including the capability of sending information about the battery such as information regarding amount of power available at the non-power line sources, type of power sources available, at the non-power line sources and any other power related information. The device 600 can use this information to make power related decisions such as which non-power lines sources to select for receiving to power the device 600 and/or charge the battery 602. This embodiment may share the same advantages as those of the other embodiments described above.

Embodiments within the scope of the present invention may include program products comprising computer-readable media for carrying or having computer-executable instructions or data structures stored thereon. Such computer-readable media can be any available media that can be accessed by a general purpose or special purpose computer. By way of example, such computer-readable media can comprise random accessory memory (RAM), read only memory (ROM), erasable programmable read only memory (EPROM), Electrically Erasable programmable read-only memory (EEPROM), compact disc read-only memory (CD-ROM) or other optical disk storage, magnetic disk storage or other magnetic storage devices, or any other medium which can be used to carry or store desired program code in the form of computer-executable instructions or data structures and which can be accessed by a general purpose or special purpose computer. Combinations of the above are also to be included within the scope of computer-readable media. Computer-executable instructions comprise, for example, instructions and data which cause a general purpose computer, special purpose computer, or special purpose processing device to perform a certain function or group of functions.

Some embodiments of the invention are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention, in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers (PCs), hand-held devices, multi-processor systems, microprocessor-based or programmable consumer electronics, network PCs, minicomputers, mainframe computers, and the like. The present subject matter may also be practiced in distributed computing environments where tasks are performed by local and remote processing devices that are linked (either by hardwired links, wireless links, or by a combination of hardwired or wireless links) through a commutations network. In a distributed computing environment, program modules may be located in both local and remote memory storage devices.

An example system for implementing the overall system or portions of the present disclosure might include a general purpose computing device in the form of a conventional computer, including a processing unit, a system memory, and a system bus that couples various system components including the system memory to the processing unit. The system memory may include ROM and RAM. The computer may also include a magnetic hard disk drive for reading from and writing to a magnetic hard disk, a magnetic disk drive reading from or waiting to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present disclosure could be accomplished with standard programming techniques with rule based logic and other logic to accomplish the various database searching steps, correlation steps, comparison steps and decision steps.

While aspects of example embodiments of the present invention have been described with reference to certain embodiments, it will be understood by those skilled in the art that various changes may be made and equivalents may be substituted without departing from the scope of example embodiments of the present invention. For example although the illustrative embodiments of the present disclosure are shown and described within the context of a single electronic device, the functionality of the single computer could be distributed over a plurality of electronic devices. In addition, many modifications may be made to adapt a particular situation to the teachings of example embodiments of the present invention without departing from its scope. Therefore, it is intended that embodiments of the present invention not be limited to the particular embodiments disclosed herein, but that representative embodiments of the present invention include all embodiments falling within the scope of the appended claims.

What is claimed is:

1. A battery pack for providing power to an electronic device, comprising:
a rechargeable battery;
a non-power line power source; and
a circuit configured to selectively deliver direct current (DC) power from the non-power line source to at least one of the rechargeable battery and the electronic device based on communication between the electronic device and the battery pack.

2. The battery pack of claim 1, wherein the circuit is configured to selectively deliver power from a plurality of non-power line sources.

3. The battery pack of claim 1, wherein the non-power line source composes at least one of a fuel cell, solar cell, inductive power, magnetic resonance power, kinetic energy conversion, thermal energy conversion and wind energy conversion.

4. The battery pack of claim 1, wherein the communication comprises a signal from the electronic device to the battery pack requesting power from the battery pack.

5. The battery pack of claim 1, wherein the communication comprises a signal from the battery pack to the electronic device indicating information about the battery pack including information regarding at least one of amount of power available at the battery pack and type of power sources available at the battery pack.

6. An electronic device, comprising:
a first power source including a first battery; and
a controller configured to communicate with an external battery pack to select receiving power from a second power source including at least one of a second battery and a non-power line power source based on available power at one or more of the first power source and the second power source.

7. The electronic device of claim 6, wherein the controller is configured to control delivery of power to the electronic device based on a predetermined algorithm.

8. The electronic device of claim 6, wherein the controller is configured to control delivery of system power to the electronic device based on available power at the power sources.

9. The electronic device of claim 6, wherein the controller is configured to control delivery of system power to the electronic device from the multiple power sources simultaneously.

10. An electronic device, comprising:
a first power source including a first battery;
a second power source including an input for receiving power from an external alternating current (AC) adapter; and
a controller configured to control delivery of system power to the electronic device from one or more of the first power source, the second power source, and a third power source from one or more non-power line sources based on power detected from one or more of the power sources.

11. The electronic device of claim 10, wherein the controller is configured to control delivery of system power to the electronic device from more than one of the power sources simultaneously.

12. The electronic device of claim 10, wherein the controller is configured to select a priority of power sources for delivering system power based on a set of priorities.

13. The electronic device of claim 12, wherein the set of priorities comprises at least one of a predefined set of priorities, a user configurable set of priorities and a dynamically determined set of priorities.

14. The electronic device of claim 10, wherein the controller is configured to control delivery of system power to the electronic device based on available power at the power sources.

15. The electronic device of claim 10, wherein the controller is configured to control delivery of system power to the electronic device based on relative cost of the power sources.

16. The electronic device of claim 10, wherein the controller is configured to control delivery of system power to the electronic device based on user specified preferences.

17. The electronic device of claim 10, wherein the controller is configured to control delivery of system power to the electronic device based on an algorithm.
